(19) United States
(12) Patent Application Publication
(10) Pub. No.: US 2006/0061593 A1
(43) Pub. Date: Mar. 23, 2006

(54) Image display unit and method of correcting brightness in image display unit

(76) Inventors: Satoshi Miura, Kanagawa (JP); Hisafumi Motoe, Saitama (JP); Yosuke Yamamoto, Chiba (JP); Takeya Meguro, Tokyo (JP)

Correspondence Address: SONNENSCHEIN NATH & ROSENTHAL LLP;Sears Tower, Wacker Drive Station, P.O. Box 061080, Chicago, IL, 60606-1080, US

(21) Appl. No.: 11/224,259

(22) Filed: Sep. 12, 2005

(30) Foreign Application Priority Data
Sep. 22, 2004 (JP) P2004-274794
May 23, 2005 (JP) P2005-149280

(51) Int. Cl. G09G 5/00

(52) U.S. Cl. 345/612

(57) ABSTRACT

While the memory amount is reduced through minimizing correction data prepared in advance, the capability of uniformity correction can be improved, compared to a related art. Correction data for correcting display unevenness between pixels for representative pixel points is stored. Correction data for pixels except for the representative pixel points is calculated by interpolation. The representative pixel points are arranged with a higher density in a pixel region with relatively finer display unevenness.

### CROSS REFERENCES TO RELATED APPLICATIONS

The present invention contains subject matters related to Japanese Patent Application JP 2004-274794 filed in the Japanese Patent Office on Sep. 22, 2004 and Japanese Patent Application JP 2005-149280 filed in the Japanese Patent Office on May 23, 2005, the entire contents of which being incorporated herein by reference.

### BACKGROUND OF THE INVENTION

1. Field of the Invention

The present invention relates to a display unit which includes a plurality of pixels and controls the level of display brightness on a pixel-by-pixel basis, for example, an image display unit suitable for an FED (Field Emission Display), an EL (Electroluminescence) display, a liquid crystal display unit or the like, and a method of correcting brightness in the image display unit.

2. Description of the Related Art

In recent years, display units have become thinner and flatter. As one of flat panel display sections (flat panel displays, hereinafter simply referred to as displays) used for display units, for example, a display using a field emission cathode has been developed. As the display using the field emission cathode, an FED is known. The FED has a large number of advantages that the FED can improve grayscale while securing a viewing angle, and the image quality is superior, the production efficiency is high, the response speed is high, the FED can operate under an extremely low temperature environment, the brightness is high, and the power efficiency is high. Moreover, the manufacturing process of the FED is simpler than the manufacturing process of a so-called active matrix liquid crystal display, and it is expected that the manufacturing cost of the FED is at least 40% to 60% lower than that of the active matrix liquid crystal display.

Now, the basic structure and the operation of the FED will be described below. The FED is a display device in which electrons are emitted from a field emission cathode through the use of field electron emission characteristics, and an acceleration electric field is applied to the electrons to accelerate the electrons, and then light emission is obtained when the electrons hit an anode electrode coated with a phosphor.

The field emission cathode includes, for example, a conical cathode device (cold cathode device) and a cathode electrode which is electrically connected to the base of the cathode device. Moreover, on a side facing the cathode electrode, a gate electrode is disposed with the cathode device in between. When a voltage Vgc is applied between the cathode electrode and the gate electrode facing each other, electrons are emitted from the cathode device. An anode electrode as an acceleration electrode is disposed on a side facing the field emission cathode and the gate electrode. When a high voltage HV is applied to the anode electrode, the electrons emitted from the cathode device are accelerated to hit a phosphor which is applied to the anode electrode, thereby light is emitted.

In general, in the FED, the gate electrode is connected to row direction (Row) wires and column direction (Column) wires to carry out matrix wiring, and the cathode device is disposed at each of intersections of the wires so as to form pixels in a matrix form. A modulation signal is inputted from the column direction wire side, and a scanning signal is sequentially applied from the row direction wire side to perform scanning. When a row wire selection voltage Vrow as a scanning signal is applied to the gate electrode from a row direction, and a column wire drive voltage Vcol as a modulation signal is applied to the cathode electrode from a column direction, a voltage difference between the gate electrode and the cathode electrode expressed as a voltage Vgc occurs, and by an electric field generated by the voltage Vgc, electrons are emitted from the cathode device. At this time, when a high voltage HV is applied to the anode electrode, electrons are attracted to the anode electrode under the following condition, thereby an anode current Ia flows in a direction from the anode electrode to the cathode electrode.
HV>Vrow (1)

At this time, when a phosphor is applied to the anode electrode, the phosphor emits light by the energy of the electrons.

Depending upon the magnitude of the voltage Vgc, the amount of electron emission changes, thereby the anode current Ia changes. In this case, the light emission amount of the phosphor, that is, light emission brightness L has the following relationship.
L∝Ia (2)

Therefore, when the voltage Vgc is changed, the light emission brightness L can be changed. In other words, when the amount of electron emission is controlled by the magnitude of the voltage Vgc, desired light emission can be obtained. Therefore, when the voltage Vgc is modulated according to a signal to be displayed, brightness modulation can be achieved.

FIG. 1 shows an example of an electron emission characteristic (a current-voltage characteristic (IV characteristic)) in the cathode device. The horizontal axis indicates the voltage Vgc, and the vertical axis indicates the current Ic. As shown in FIG. 1, in the cathode device, although a small current starts flowing from a threshold Vo, electrons contributing to light emission are not emitted at a cutoff voltage Von (for example, 20 V) or less, and when a voltage exceeding the cutoff voltage Von is applied as the voltage Vgc, electrons are emitted to generate a current contributing to light emission.

As the row wire selection voltage Vrow, for example, a voltage of 35 V at the time of selection or a voltage of 0 V at the time of non-selection is applied. On the other hand, as the column wire drive voltage Vcol, for example, a modulation signal of 0 to 15 V is applied according to an input image signal level.

In this case, when the row wire selection voltage Vrow is in a selection state, that is, a voltage of 35 V is applied, and the column wire drive voltage Vcol is 0 V, a difference voltage Vgc between a gate and a cathode is 35 V, so the amount of electrons emitted from the cathode device increases, and emitted light in the phosphor has high brightness. Likewise, when the row wire selection voltage Vrow is in a selection state, that is, 35 V is applied, and the column wire drive voltage Vcol is 15 V, the difference voltage Vgc between the gate and the cathode is 20 V. However, as emitted electrons have the emission characteristic shown in FIG. 1, when the difference voltage Vgc is 20 V, enough electrons to contribute to light emission are not emitted. Therefore, light emission does not occur.

As described above, when the row wire selection voltage Vrow is brought into a selection state, and the column wire drive voltage Vcol is controlled within a range from 0 V to 15 V according to an input image signal level, desired brightness can be displayed.

In the case where a panel is successively displayed, while cathode device arrays are sequentially driven (scanned) on a row-by-row basis through applying the row wire selection voltage Vrow to the gate electrode, a modulation signal (column wire drive voltage Vcol) for one line of an image is applied to a cathode electrode group at the same time, thereby the amount of electron beam irradiation to the phosphor is controlled to display an image on a line-by-line basis.

In the FED, it is known that the following issues potentially exist.

(i) Even if the same voltage Vgc is applied, the amount of electron emission from each cathode device is not the same due to variations in the manufacturing process of the cathode device or wiring. In other words, even if all pixels are driven at the same signal level, the brightness of each display pixel is not the same (that is, the Vgc-brightness characteristic (gamma characteristic) of each pixel is not perfectly the same). In this case, the variations in the manufacturing process have some patterns, so there are a dark area and a bright area in a screen, which are seen as brightness unevenness. Moreover, the brightness unevenness between colors is seen as color unevenness.

(ii) The voltage Vgc differs with location in the screen by a wiring load.

The FED has a matrix wiring structure, so the wiring resistance according to the wire length between pixels occurs. Moreover, row wires and column wires intersect with each other in pixel portions, so a wiring capacity (parasitic capacity) according to the area of the pixel portion is generated. The wiring resistance and the wiring capacity are wiring loads. The larger the distance from a driver is, the larger a voltage drop due to the wiring loads becomes, and there is a voltage difference between near and far from the driver, so even if the same voltage is applied from the driver, the applied voltage Vgc is not the same in each pixel, thereby uniform light emission is not obtained. Therefore, a shading phenomenon that light is brighter near the driver and the larger the distance from the driver is, the darker the light is occurs.

They are fundamental issues about uniformity of image display. Next, an example of a correction system for solving the issues about uniformity in a related art will be described below. In the correction system, correction data is prepared in advance, and the correction data is added to or subtracted from an original signal to correct the original signal, thereby to improve the uniformity.

More specifically, at first, as shown in FIG. 2A, an effective screen 42 in a display unit 41 is virtually separated into meshes with a larger spacing than an actual pixel spacing, and the brightness in a separated grid point 43 is measured at each input signal level. As the data amount is large, so all signal levels which can be displayed in the display unit 41 is not sampled, but only representative signal levels are sampled, and then the brightness is measured at each of the sampled signal levels. Then, on the basis of measurement data, correction data in each grid point 43 at each of sampled input signal levels is calculated, and is stored in a memory as a look-up table.

In FIG. 2B, having the correction data 44 in each grid point 43 at each of the sampled input signal levels is conceptually shown as a three-dimensional pixel space. The parameter of the three-dimensional pixel space shown in FIG. 2B includes pixel positions in a horizontal direction and a vertical direction and signal levels. As shown in FIGS. 2A and 2B, the brightness in each grid point 43 at an input signal level n is measured by one measurement, and the correction data 44 for each grid point 43 at the input signal level n is calculated. When this process is performed at each input signal level, the correction data 44 for each grid point 43 at each input signal level is calculated.

In this case, it is necessary to have (the number of grid points in a vertical direction in a screen×the number of grid points in a horizontal direction in the screen×the number of samples of input signal levels) items of data as the correction data 44 in the form of a look-up table. Then, the correction data for all pixels at all signal levels is formed by interpolation on the basis of the correction data 44 for each grid point 43 stored in the look-up table.

FIG. 3 three-dimensionally shows the concept of the calculation of correction data by interpolation. In the three-dimensional pixel space shown in the drawing, the correction data for an interpolation point 45 is calculated on the basis of the correction data for 8 grid points 43 around the interpolation point 45. The value of the correction data for the interpolation point 45 is a value according to a distance from each of the 8 grid points 43. A method of calculating data by interpolation includes linear interpolation.

FIGS. 4A and 4B show the concept of the calculation of correction data by linear interpolation. FIG. 4A shows linear interpolation in a vertical direction, and FIG. 4B shows linear interpolation in a horizontal direction. In FIG. 4A, when the position of a target interpolation point 45 is L3, the correction data for the target interpolation point 45 is determined by the values of the correction data for grid points 43 in neighborhood points L1 and L2 in a vertical direction and distances a and b from the points L1 and L2 to the point L3. More specifically, the correction data for the target interpolation point 45 is expressed by the following formula. In the formula, L1, L2 and L3 indicate data values.

ti L3=(bL1+aL2)/(a+b)

Likewise, in FIG. 4B, when the position of the target interpolation point 45 is L13, the correction data for the interpolation point 45 is determined by the values of correction data in neighborhood points L11 and L12 in a horizontal direction and distances a and b from the points L11 and L12 to the point L13. More specifically, the correction data for the target interpolation point 45 is expressed by the following formula. In the formula, L11, L12 and L13 indicate data values. The data values in the points L11 and L12 can be determined by the above-described linear interpolation in a vertical direction.
L13=(bL11+aL12)/(a+b)

Thus, when linear interpolation in a vertical direction and linear interpolation in a horizontal direction are combined, the data value in any position can be determined. The interpolation between sampled signal levels can be determined by the same calculation as those in FIGS. 4A and 4B, although it is not shown.

A technique for improving brightness evenness through the use of the correction data is described in Japanese Unexamined Patent Application Publication No. 2000-122598. In the document, in a display unit including a plurality of light emitting devices, a light emission command value is corrected through referring to a correction value table corresponding to the light emitting devices, and a drive section is controlled on the basis of the corrected light emission command value. The correction value table stores correction value data for each light emitting device or correction value data for each small region of a display section.

### SUMMARY OF THE INVENTION

Now, the capability to correct “unevenness” by the above-described correction system in the related art will be considered below. FIG. 5 shows the arrangement of grid points for correction data calculation at an input signal level. In an effective screen 190, grid points 191 are arranged with a fixed spacing regardless of the presence or absence of unevenness. Therefore, as shown in the drawing, when there are an A region 192 in which unevenness appears in a relatively wide area and a B region 193 in which unevenness appears in a relatively small area, there is a possibility that the grid points 191 exist in the A region 192, but no grid point 191 exists in the B region 193. In the case where the grid points 191 exist as in the case of the A region 192, correction data corresponding to unevenness can be obtained, so the unevenness can be easily corrected. However, in the case where no grid point 191 exists as in the case of the B region 193, correction data corresponding to unevenness may not be obtained, so unevenness may not be corrected. Therefore, the correction capability is high in the case where an uneven area is larger than a separated region of a screen at the time where the grid points 191 are set, and when the uneven area is small, the correction capability is low. In other words, the finer the unevenness is (the smaller the area in which the unevenness appears is), the lower the correction capability becomes. In Japanese Unexamined Patent Application Publication No. 2000-122598, the same issue occurs in the case where correction value data for each small area of a display section is stored.

In order to correct finer unevenness, as shown in FIG. 6, it is necessary to increase the number of grid points and reduce spacings between grid points through reducing the size of the separated region of the screen. In other words, it is necessary to add grid points 194 in addition to grid points 191 shown in FIG. 5 and increase correction data. In an example shown in FIG. 5, there are 48 grid points 191, and, in FIG. 6, grid points 194 are added, so there are 165 grid points in total. Thereby, grid points exist in the B region 193 with fine unevenness, so the correction data can be obtained, and the unevenness can be corrected. An ultimate way is to reduce the size of the separated region to the size of one pixel, and set grid points in all pixels; however, if doing so, it is necessary to store correction data for all pixels as a look-up table, thereby a necessary memory amount is extremely increased. The ultimate way is not practical, because the memory size is too large. In Japanese Unexamined Patent Application Publication No. 2000-122598, the same issue occurs in the case where correction value data for each light emission device is stored. Therefore, a technique for improving the correction capability while minimizing the amount of correction data stored in the look-up table is desired.

In view of the foregoing, it is desirable to provide an image display unit capable of improving the capability of uniformity correction compared to that in a related art while reducing a memory amount through minimizing correction data prepared in advance, and a method of correcting brightness in an image display unit.

According to an embodiment of the present invention, there is provided an image display unit including a plurality of pixels, and controlling the level of display brightness on a pixel-by-pixel basis, and the image display unit including: a storing means for storing correction data for correcting display unevenness between pixels for representative pixel points set in an effective screen; an interpolation means for calculating correction data for pixels except for the representative pixel points by interpolation through referring to the correction data stored in the storing means; and a signal processing means for performing a correction process on an input signal on the basis of the correction data stored in the storing means and the correction data calculated by interpolation so that display brightness at the same input signal level becomes the same between pixels. In the image display unit, the arrangement of the representative pixel points is set according to display unevenness measured before performing the correction process so that the representative pixel points are arranged with a higher density in a pixel region with relatively finer display unevenness than in a pixel region with rough display unevenness in the effective screen, and the correction data stored in the storing means is allocated more to the pixel region with relatively finer display unevenness according to the measured display unevenness, compared to the pixel region with rough display unevenness.

According to an embodiment of the present invention, there is provided a method of correcting brightness in an image display unit, the image display unit including a plurality of display pixels and controlling the level of display brightness on a pixel-by-pixel basis, the method including the steps of: storing correction data for correcting display unevenness between pixels for representative pixel points set in an effective screen; calculating correction data for pixels except for the representative pixel points by interpolation through referring to the stored correction data; and performing a correction process on an input signal on the basis of the stored correction data and the correction data calculated by interpolation so that display brightness at the same input signal level becomes the same between pixels. In the method, the arrangement of the representative pixel points is set according to display unevenness measured before performing the correction process so that the representative pixel points are arranged with a higher density in a pixel region with relatively finer display unevenness than in a pixel region with rough display unevenness in the effective screen, and the stored correction data is allocated more to a pixel region with relatively finer display unevenness according to the measured display unevenness, compared to the pixel region with rough display unevenness.

Herein, in the invention, “display unevenness” means a display state in which pixels supposed to be even are displayed as an uneven image such as brightness unevenness or color unevenness.

In the image display unit and the method of correcting brightness in an image display unit according to the embodiment of the invention, correction data for correcting display unevenness between pixels for representative pixel points is stored in the storing means. Correction data for pixels except for the representative pixel points is calculated by interpolation through referring to the correction data stored in the storing means. On the basis of the correction data stored in the storing means and the correction data calculated by interpolation, a correction process on an input signal is performed.

In the embodiment of the invention, the arrangement of the representative pixel points is set according to display unevenness measured before performing the correction process so that the representative pixel points are arranged with a higher density in a pixel region with relatively finer display unevenness according to display unevenness, so the correction data stored in the storing means is allocated more to the pixel region with relatively finer display unevenness. Thereby, while a correction process with high precision is performed in a pixel region with fine unevenness, a correction process with minimum precision can be performed in a pixel region with rough unevenness through reducing the correction data stored in the storing means. Thereby, while the memory amount is reduced through minimizing the correction data stored in the storing means, the capability of uniformity correction can be improved, compared to a related art.

In the image display unit and the method of correcting brightness in an image display unit according to the embodiment of the invention, the arrangement of the representative pixel points is set according to display unevenness so that the representative pixel points are arranged with a higher density in a pixel region with relatively finer display unevenness, and the correction data stored in the storing means is allocated more to the pixel region with relatively finer display unevenness, so while a correction process with higher precision is performed in the pixel region with finer unevenness, a correction process with minimum precision can be performed in a pixel region with rough unevenness through reducing the correction data stored in the storing means. Thereby, while the memory amount is reduced through minimizing the correction data prepared in advance, the capability of uniformity correction can be improved, compared to a related art.

Other and further objects, features and advantages of the invention will appear more fully from the following description.

### BRIEF DESCRIPTION OF THE DRAWINGS

FIG. 1 is a plot showing an electron emission characteristic (a current-voltage characteristic (IV characteristic)) in a cathode device of an FED;

FIGS. 2A and 2B are illustrations describing the concept of uniformity correction in a related art;

FIG. 3 is an illustration describing the concept of calculation of correction data by interpolation;

FIGS. 4A and 4B are illustrations describing the concept of calculation of correction data by linear interpolation, FIG. 4A shows linear interpolation in a vertical direction and FIG. 4B shows linear interpolation in a horizontal direction.

FIG. 5 is an illustration for describing an issue in a correction system in a related art;

FIG. 6 is an illustration for describing a technique for improving the correction system in the related art;

FIG. 7 is a block diagram of the whole structure of an image display unit according to an embodiment of the invention;

FIG. 8 is a schematic view of a display panel in the image display unit shown in FIG. 7;

FIG. 9 is a schematic sectional view of a pixel portion in the image display unit shown in FIG. 7;

FIG. 10 is a block diagram of the structure of a circuit portion relating to uniformity correction in the image display unit shown in FIG. 7;

FIG. 11 is an illustration showing the concept of an offset value as correction data;

FIG. 12 is an illustration showing an example of the formation of a desired brightness curve;

FIG. 13 is a block diagram describing a method of determining the extent of the fineness of display unevenness;

FIG. 14 is an illustration showing the concept of frequency separation for determining the extent of the fineness of display unevenness;

FIG. 15 is an illustration showing an example of the arrangement of grid points according to display unevenness; and

FIG. 16 is a block diagram showing the structure of a circuit portion relating to color unevenness correction.

### DETAILED DESCRIPTION OF THE PREFERRED EMBODIMENTS

A preferred embodiment will be described in detail below referring to the accompanying drawings.

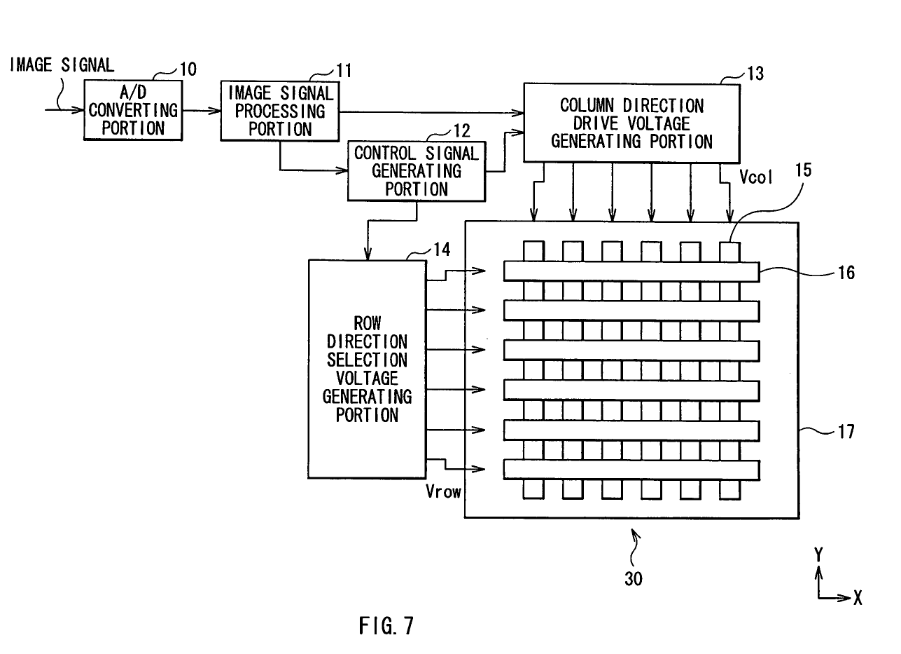

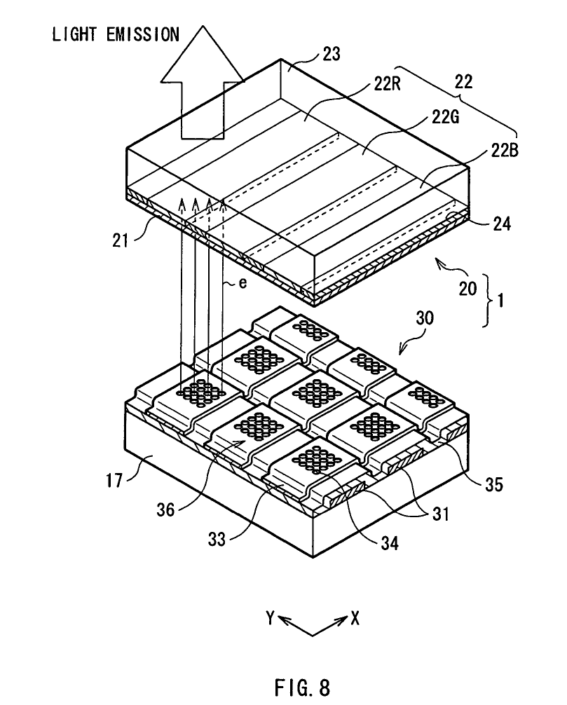

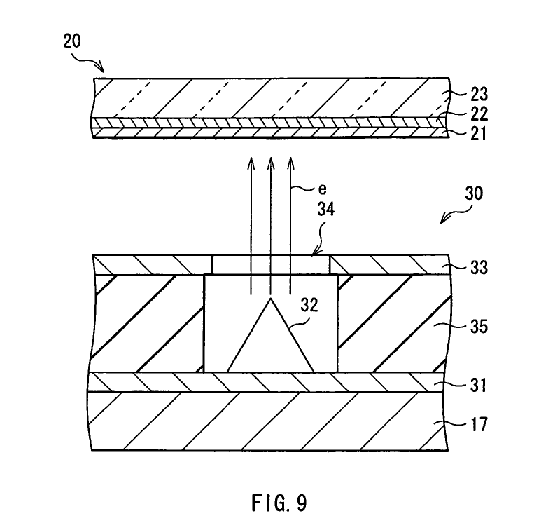

FIG. 7 shows the whole structure of an image display unit according to an embodiment of the invention. FIG. 8 schematically shows the structure of a display panel 1 in the image display unit. FIG. 9 schematically shows the structure of a pixel portion of the display panel 1. In the embodiment, an image display unit using an FED as the display panel 1 will be described as an example.

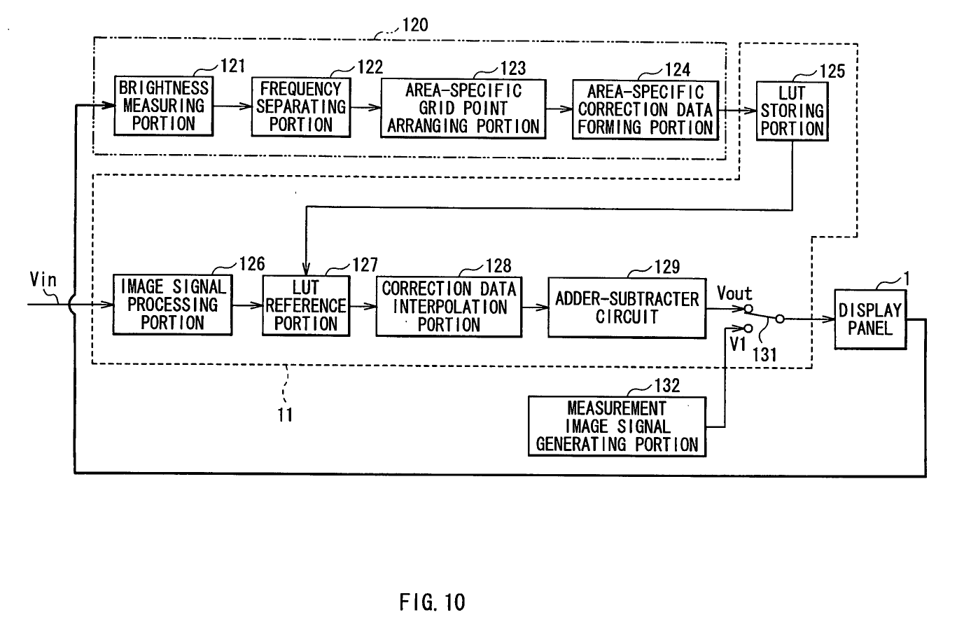

As shown in FIG. 7, the image display unit includes an A/D (analog/digital) converting portion 10 which converts an analog image signal into a digital signal to output the digital signal, an image signal processing portion 11 which performs various signal processes such as image quality adjustment on a digital image signal, a column direction drive voltage generating portion 13 and a row direction selection voltage generating portion 14 which drive the display panel 1, and a control signal generating portion 12 which outputs an appropriate timing pulse to the column direction drive voltage generating portion 13 and the row direction selection voltage generating portion 14 through using a horizontal synchronous signal H and a vertical synchronous signal V included in a image signal as inputs. The image signal inputted into the image signal processing portion 11 includes 8-bit digital image signals for R (red), G (green) and B (blue) and the horizontal synchronous signal H and the vertical synchronous signal V. In the case where a digital signal is inputted as an image signal from the start, the A/D converting portion 10 can be removed. The image signal processing portion 11 has a processing circuit for correcting display unevenness as will be described later referring to FIG. 10.

As shown in FIGS. 8 and 9, the display panel 1 includes an anode panel 20 and a cathode panel 30 which face each other with a predetermined spacing in between. An electron emission region 36 between the anode panel 20 and the cathode panel 30 is maintained in an almost vacuum state.

The anode panel 20 includes an anode electrode 21 made of a transparent body with a layer shape which is formed on a substrate portion 23 made of, for example, a glass substrate. The anode electrode 21 is coated with a phosphor layer 22. The phosphor layer 22 includes three phosphor layers 22R, 22G and 22B corresponding to the primary colors R (red), G (green) and B (blue) of light. A color image can be displayed by light emission from the phosphor layers 22R, 22G and 22B. A black matrix 24 is formed between the phosphor layers 22R, 22G and 22B. In order to simplify the description, the embodiment will be described without distinction between colors in color display, except for the case where the distinction of colors is specifically necessary.

The cathode panel 30 includes a supporting body 17, a column direction wire 15 and a row direction wire 16 which are disposed on the top surface of the supporting body 17. The column direction wire 15 extends to a column direction (a Y direction in FIG. 7), and a plurality of column direction wires 15 are aligned in a row direction (an X direction in FIG. 7). An end of each column direction wire 15 is electrically connected to the column direction drive voltage generating portion 13. The row direction wire 16 extends to a row direction, and a plurality of row direction wires 16 are aligned in a column direction. An end of each row direction wire 16 is electrically connected to the row direction selection voltage generating portion 14. Display pixels are formed in a matrix form at intersections of the column direction wires 15 and the row direction wires 16 which are aligned in a matrix form so as to cross each other, and the display pixels at the intersections emit light according to a voltage difference between a column wire drive voltage Vcol applied through the column direction wire 15 and a row wire selection voltage Vrow applied through the row direction wire 16.

In the cathode panel 30, a cathode electrode 31 is formed on the supporting body 17. As shown in FIG. 9, for example, a conical cathode device (cold cathode device) 32 is disposed on the cathode electrode 31. In general, a plurality of cathode devices 32 are disposed for 1 pixel. The cathode electrode 31 and the cathode devices 32 are electrically connected to each other. The cathode electrode 31 and the cathode devices 32 constitute a field emission cathode.

A gate electrode 33 is disposed on a side facing the cathode electrode 31 with the cathode devices 32 and an insulating layer 35 in between. When a voltage Vgc is applied between the cathode electrode 31 and the gate electrode 33 facing each other, electrons e are emitted from the cathode devices 32. In the gate electrode 33, an aperture portion 34 through which the electrons e emitted from each cathode device 32 pass is disposed in a portion corresponding to the cathode device 32.

The anode electrode 21 faces the gate electrode 33 on a side of a direction where the electrons e are emitted from the cathode device 32. The anode electrode 21 acts as an acceleration electrode. In other words, when a high voltage HV is applied to the anode electrode 21, the electrons e emitted from the cathode device 32 is accelerated toward the anode electrode 21.

Such a pixel structure is formed at each of the intersections of the row direction wires 16 and the column direction wires 15 in the cathode panel 30 so as to form pixels in a matrix form. In general, the gate electrode 33 is electrically connected to the row direction wires 16, and the cathode electrode 31 is electrically connected to the column direction wires 15. Then, when the row wire selection voltage Vrow is applied to the gate electrode 33 as a scanning signal from a row direction, and the column wire drive voltage Vcol is applied to the cathode electrode 31 as a modulation signal from a column direction, a voltage difference expressed as a voltage Vgc occurs between the gate electrode 33 and the cathode electrode 31, and the electrons e are emitted from the cathode drive 32 by an electric field generated by the voltage Vgc. At this time, when the high voltage HV is applied to the anode electrode 21, the electrons e are attracted to the anode electrode 21, thereby an anode current Ia flows in a direction from the anode electrode 21 to the cathode electrode 31. At this time, by the energy of the electrons e which arrive at the anode electrode 21, the phosphor layer 22 in a position corresponding to the anode electrode 21 emits light.

The row direction selection voltage generating portion 14 sequentially applies a scanning signal to each row direction wire 16, and applies the scanning signal (the row wire selection voltage Vrow) to each row direction wire 16 with appropriate timing on the basis of a timing pulse outputted from the control signal generating portion 12. The row wire selection voltage Vrow selects and drives the pixels on a line-by-line basis alternatively and sequentially.

The column direction drive voltage generating portion 13 applies a modulation signal to each column direction wire 15, and mainly includes a shift register for inputting a digital image signal for one line (=1H period (1 horizontal scanning period), a line memory for holding the image signal for a 1H period, a D/A (digital/analog) converter for converting the digital image signal for the 1H period into an analog voltage to apply the analog voltage for the 1H period, and the like (not shown). The column direction drive voltage generating portion 13 converts a modulation signal corresponding to a digital image signal from the image signal processing portion 11 into an analog modulation signal by a D/A converter (not shown) to apply the analog modulation signal as the column wire drive voltage Vcol to each column direction wire 15. A plurality of column direction wires R1, G1 and B1 through RN, GN and BN (N=an integer) as the column direction wires 15 for pixel arrays of R, G and B are connected to the column direction drive voltage generating portion 13, thereby the column wire drive voltage Vcol is applied to each column direction wire 15 for the 1H period at the same time.

FIG. 10 shows the structure of a circuit portion relating to uniformity correction which is the most characteristic portion in the embodiment. The image signal processing portion 11 include a LUT (look-up table) storing portion 125, an image signal processing circuit 126, a LUT reference portion 127, a correction data interpolation portion 128, an adder-subtracter circuit 129 and a selector switch 131. The selector switch 131 includes two input terminals, and the adder-subtracter circuit 129 and measurement image signal generating portion 132 disposed outside the image signal processing portion 11 are connected to the input terminals.

In the embodiment, the LUT storing portion 125 corresponds to a specific example of “a storing means” in the invention, and the correction data interpolation portion 128 corresponds to a specific example of “an interpolation means” in the invention. Moreover, the adder-subtracter circuit 129 corresponds to a specific example of “a signal processing means” in the invention.

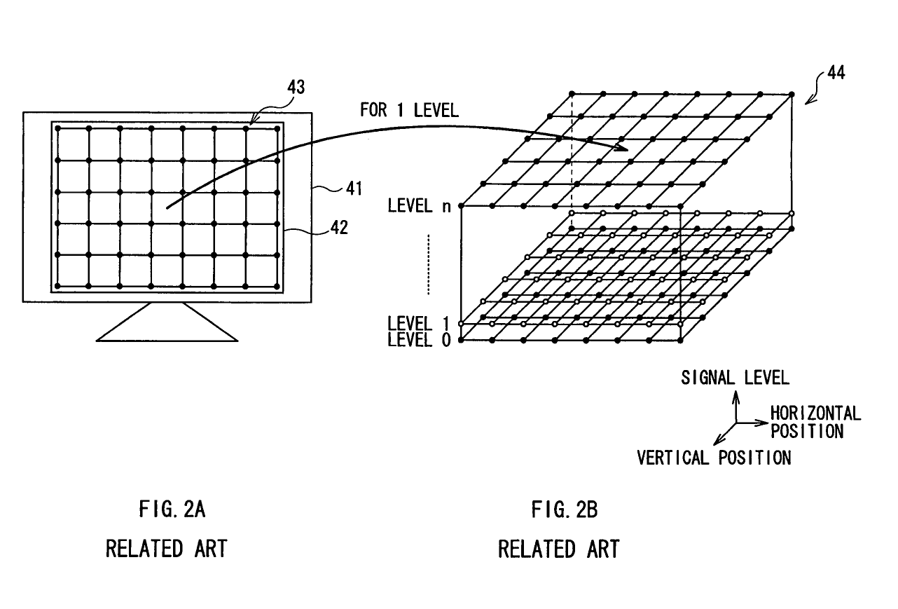

The LUT storing portion 125 includes a semiconductor memory or the like, and stores correction data for correcting display unevenness between pixels in the form of a look-up table. In the LUT storing portion 125, correction data for representative pixel points set in an effective screen at representative signal levels is stored as correction data. In other words, in the LUT storing portion 125, basically as in the case of correction data 44 conceptually shown in FIGS. 2A and 2B, correction data for each grid point 43 as a representative pixel point set in an effective screen 42 at sampled input signal levels is stored. However, in the embodiment, a method of arranging representative pixel points is different from that in a related art. In the related art, representative pixel points are arranged with an equal spacing regardless of display unevenness; however, in the embodiment, the representative pixel points are arranged according to display unevenness measured before a correction process so that more pixel points are arranged in a pixel region with relatively finer display unevenness, compared to a pixel region with rough display unevenness. Thereby, the correction data stored in the LUT storing portion 125 is allocated more to the pixel region with relatively finer display unevenness according to measured display unevenness, compared to the pixel region with rough unevenness. A specific method of setting the arrangement will be described in detail later.

The correction data stored in the LUT storing portion 125 is formed by a correction data forming apparatus 120 in advance. The formation of the correction data by the correction data forming apparatus 120 is performed, for example, as an initial setting at the time of manufacturing. The correction data forming apparatus 120 includes a brightness measuring portion 121, a frequency separating portion 122, an area-specific grid point arranging portion 123 and an area-specific correction data forming portion 124. The brightness measuring portion 121 measures the display brightness of the display panel 1, and includes, for example, a CCD (Charge Coupled Device) camera or the like.

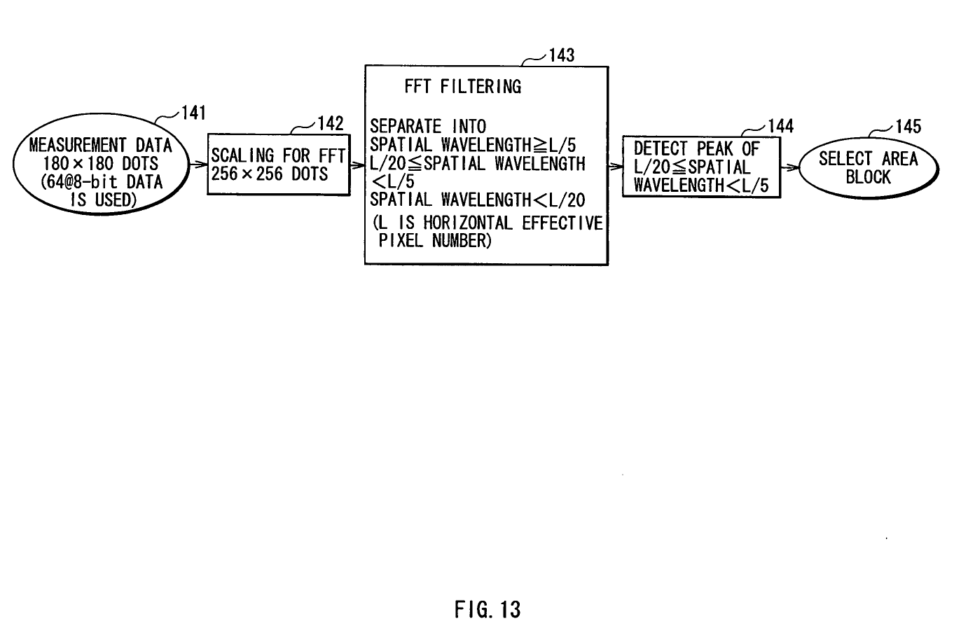

As shown in FIG. 13, the frequency separating portion 122 includes a scaling processing portion 142, an FFT filter 143, a peak detecting portion 144 and an area block selecting portion 145. The frequency separating portion 122 separates a brightness distribution in an effective screen into a plurality of spatial frequency components on the basis of data measured by the brightness measuring portion 121 to determine where and how much the display unevenness appears on a screen. The determining method will be described later.

The area-specific grid point arranging portion 123 determines the arrangement of the grid points as the above-described representative pixel points on the basis of the information of display unevenness determined by the frequency separating portion 122. The area-specific correction data forming portion 124 forms correction data for each grid point arranged by the area-specific grid point arranging portion 123 on the basis of data measured by the brightness measuring portion 121.

The image signal processing circuit 126 performs a scaling process for adjusting an input image signal Vin according to the pixel number of the display panel 1, an image quality control process set by a user or the like on the input image signal Vin. The LUT reference portion 127 reads the correction data stored in the LUT storing portion 125. The correction data interpolation portion 128 refers the correction data stored in the LUT storing portion 125 through the LUT reference portion 127, and calculates correction data for a pixel except for representative pixel points by interpolation on the basis of the referred correction data. The adder-subtracter circuit 129 performs a correction process on the input image signal Vin on the basis of the correction data stored in the LUT storing portion 125 and the correction data calculated by the correction data interpolation portion 128. The correction data is the data of an offset value from a desired brightness curve as will be described later. The adder-subtracter circuit 129 performs a process of adding the offset value to an input signal value and subtracting the offset value from the input signal value. Thereby, a process of correcting an input signal is performed so that the display brightness at the same input signal level is the same between the pixels.

The measurement image signal generating portion 132 is used when the correction data is formed by the correction data forming apparatus 120, and generates an image signal for brightness measurement V1. The selector switch 131 selects either an output image signal Vout from the adder-subtracter circuit 129 or the image signal for measurement V1 from the measurement image signal generating portion 132 is displayed on the display panel 1.

Next, the operation of the image display unit with the above structure will be described below.

At first, the basic operation of the image display unit will be described below. In FIG. 7, an analog image signal inputted into the A/D converting portion 10 is converted into a digital image signal, and the digital image signal is outputted to the image signal processing portion 11. In the image signal processing portion 11, various signal processes such as image quality adjustment is performed on the digital image signal. The image signal includes, for example, 8-bit digital image signals for R, G and B, the horizontal synchronous signal H and the vertical synchronous signal V. The digital image signals for R, G and B are inputted into the column direction drive voltage generating portion 13.

On the other hand, the horizontal synchronous signal H and the vertical synchronous signal V are inputted into the control signal generating portion 12, and the control signal generating portion 12 generates an image capture start pulse for column wire drive which indicates timing for starting to capture an image in the column direction drive voltage generating portion 13 and a column wire drive start pulse which indicates timing for generating an analog image voltage which is D/A converted in the column direction drive voltage generating portion 13. The control signal generating portion 12 further generates a row wire drive start pulse indicating timing for starting to drive the row wire selection voltage Vrow in the row direction selection voltage generating portion 14 and a shift clock for row wire selection as a reference shift clock for sequentially selecting and driving the row wire selection voltage Vrow on a line-by-line basis from above. The column direction drive voltage generating portion 13 and the row direction selection voltage generating portion 14 drive the display panel 1 with timing based on a drive timing pulse generated on the basis of the synchronous signals.

The row direction selection voltage generating portion 14 sequentially applies the row wire selection voltage Vrow as a scanning signal to each row direction wire 16. The column direction drive voltage generating portion 13 applies the column wire drive voltage Vcol as a modulation signal to each column direction wire 15. In the panel structure shown in FIGS. 8 and 9, the gate electrode 33 is electrically connected to the row direction wire 16, and the cathode electrode 31 is electrically connected to the column direction wire 15, so the row wire selection voltage Vrow is applied to the gate electrode 33 from a row direction, and the column wire drive voltage Vcol is applied to the cathode electrode 31 from a column direction. Thereby, a voltage difference between the gate electrode 33 and the cathode electrode 31 which is expressed as the voltage Vgc occurs, and by an electric field generated by the voltage Vgc, the electrons e are emitted from the cathode device 32. The emitted electrons e are accelerated by the anode electrode 21 to hit the anode electrode 21. By the energy of the electrons e hitting the anode electrode 21, the phosphor layer 22 in a position corresponding to the anode electrode 21 emits light. An image is displayed by light emission.

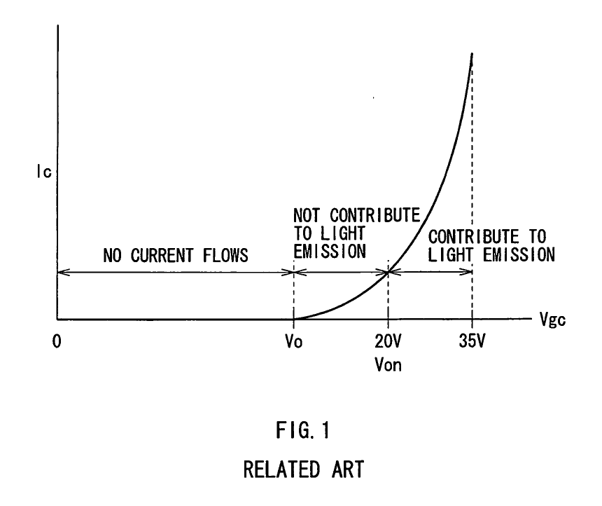

In this case, the amount of electron emission is controlled by the magnitude of the voltage Vgc, and desired light emission can be obtained. Therefore, when the voltage Vgc is modulated according to a signal to be displayed, brightness modulation can be achieved in each pixel. As the row wire selection voltage Vrow, for example, a voltage of 35 V at the time of selection or a voltage of 0 V at the time of non-selection is applied. On the other hand, as the column wire drive voltage Vcol, for example, a modulation signal of 0 to 15 V is applied according to an input image signal level. In this case, when the row wire selection voltage Vrow is in a selection state, that is, a voltage of 35 V is applied, and the column wire drive voltage Vcol is 0 V, a difference voltage Vgc between a gate and a cathode is 35 V, so the amount of electrons emitted from the cathode device 32 increases, and emitted light in the phosphor has high brightness. Likewise, when the row wire selection voltage Vrow is in a selection state, that is, 35 V is applied, and the column wire drive voltage Vcol is 15 V, the difference voltage Vgc between the gate and the cathode is 20 V; however, emitted electrons have an emission characteristic shown in FIG. 1, so when the difference voltage Vgc is 20 V, enough electrons to contribute to light emission are not emitted. Therefore, light emission does not occur. As described above, when the row wire selection voltage Vrow is brought into a selection state, and the column wire drive voltage Vcol is controlled within a range from 0 V to 15 V according to an input image signal level, desired brightness can be displayed.

Next, the operation relating to uniformity correction will be described below. The operation relating to the formation of correction data by the correction data forming apparatus 120 will be also described below.

In FIG. 10, at first, in order to form the correction data, the selector switch 131 is turned to the measurement image signal generating portion 132 side, and the image signal for brightness measurement V1 is outputted. As the image signal for brightness measurement V1, some flat field signals having a certain level interval from a black level to a white level (for representative signal levels (grayscale levels)) are generated. Then, the generated image signal for brightness measurement V1 is displayed on the display panel 1 targeted for measurement, and the display brightness is measured by the brightness measuring portion 121 at each input signal level. In general, the brightness relative to a screen position is measured through taking the whole one screen by a CCD camera or the like. It is necessary to measure the brightness data relative to the screen position with higher precision than in the case of the correction data finally stored in the LUT stored portion 125.

Next, the measured brightness data is spatially separated by frequency in the frequency separating portion 122. Thereby, where and how much display unevenness appears on the screen can be determined. Although the detail will be described later, the fineness of display unevenness has, for example, two threshold values, and is separated into three frequency bands. For example, display unevenness to the extent that 20 or more Sin waveforms are shown in the horizontal width of the effective screen is determined as “very fine unevenness”, display unevenness to the extent that 5 to 20 Sin waveforms are shown is determined as “fine unevenness” and display unevenness to the extent that 5 or less Sin waveforms are shown is determined as “rough unevenness” or “no unevenness”. Next, in the area-specific grid point arranging portion 123, the arrangement of grid points (representative pixel points targeted for correction data calculation) corresponding to the fineness of display unevenness is determined from a result obtained by the frequency separation by the frequency separating portion 122. For example, in a pixel area with “very fine unevenness” and “fine unevenness”, the grid points are arranged with a high density, and on the other hand, in a pixel area with “rough unevenness”, the grid points are arranged with a low density.

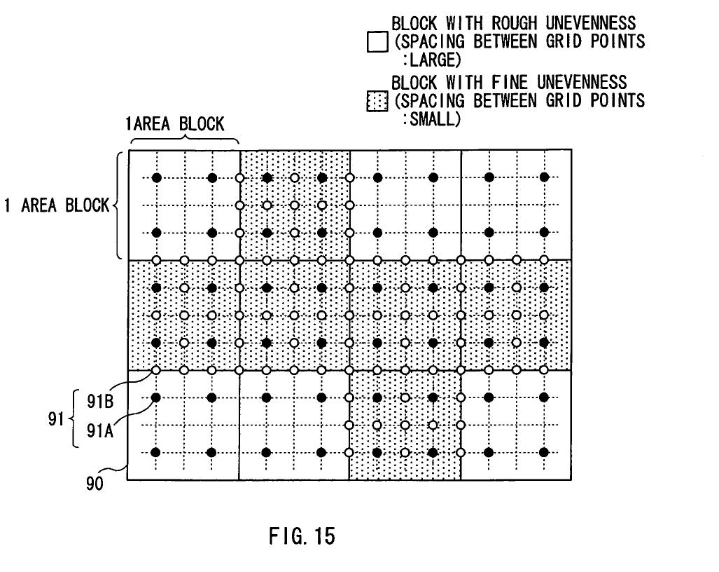

FIG. 15 shows an example of the arrangement of the grid points. In the frequency separating portion 122, an effective screen 90 is virtually separated into meshes to set a plurality of pixel area blocks. In the example shown in FIG. 15, the effective screen 90 is widely separated into 12 (3 deep×4 wide) area blocks. The extent of display unevenness in each area block is determined. In the example of FIG. 15, the area blocks are widely separated into two blocks, that is, “very fine unevenness, fine unevenness” and “rough unevenness”, and 6 hatched area blocks are blocks with “very fine unevenness, fine unevenness”, and other area blocks are blocks with “rough unevenness”. As shown in the drawing, as the grid points 91, grid points 91A are arranged in a block with “rough unevenness”, and grid points 91B are arranged in addition to the grid points 91A in a block with “very fine unevenness, fine unevenness”. Thereby, in the block with “rough unevenness”, the spacing between grids is relatively large, and in the block with “very fine unevenness, fine unevenness”, the spacing between grids is small.

Next, when the arrangement of the grid points 91 is set in the above manner, in the area-specific correction data forming portion 124, an offset value in each grid point 91 is determined on the basis of data measured by the brightness measuring portion 121 as will be described later. The offset value is linked to the position information of each grid point 91, and is stored in the LUT storing portion 125 as correction data in the form of a look-up table.

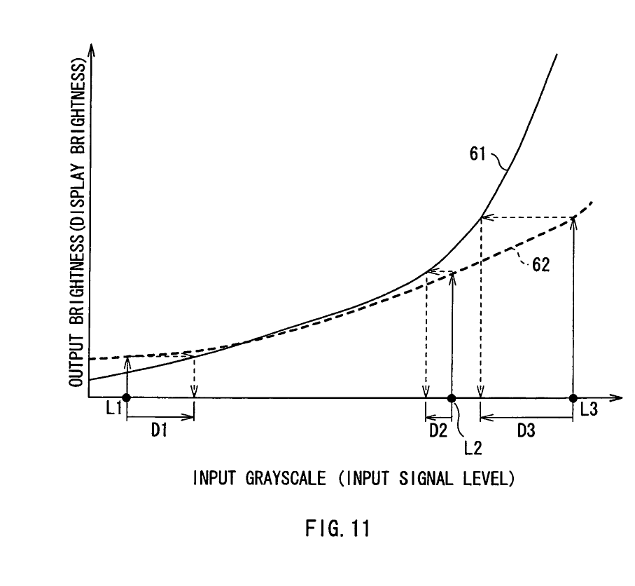

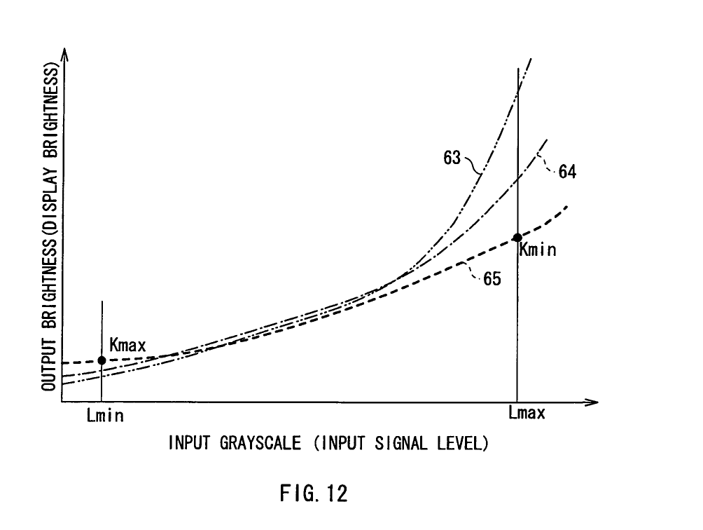

Now, referring to FIGS. 11 and 12, an example of the formation of actual correction data in each grid point will be described below. Herein, an example of the correction of brightness unevenness will be described below. In FIGS. 11 and 12, the horizontal axis indicates the grayscale level (signal level) of the input image signal Vin, and the vertical axis indicates brightness actually shown on the display panel 1. As shown in FIG. 11, the correction of brightness unevenness may be performed through setting a desired brightness curve 62 which shows an ideal relationship of display brightness to the input signal level in advance, and conforming the relationship of display brightness to the input signal level in all pixels to the desired brightness curve 62. For that purpose, in order to obtain a desired brightness level when an input signal with a certain level is inputted, it is only necessary to determine the appropriate extent to which the signal value should be shifted. For example, in FIG. 11, in the case where the brightness curve of a pixel is a curve indicated by a numeral 61, the offset values at input signal levels L1 through L3 are determined as shown in D1 through D3. In the case where the input signals with the signal levels L1 through L3 are applied, when the offset values D1 through D3 are added to or subtracted from the input signal values, the display brightness conforms to the desired brightness curve 62. When such an offset value in each grid point 91 is determined, correction data stored in the LUT storing portion 125 is formed.

The desired display brightness curve 62 is formed on the basis of actual brightness measurement data measured by, for example, the brightness measuring portion 121. In FIG. 12, curves 63 through 65 are brightness curves obtained by the measurement. At first, in the measured brightness curves, two points Kmin and Kmax, that is, brightness at the darkest point Kmin in the case where the input signal is at a maximum level Lmax, and brightness at the brightest point Kmax in the case where the input signal is at a minimum level Lmin are determined. The desired display brightness curve 62 is generally a curve or a line passing through the two points Kmin and Kmax. As a method of determining a curve or a line passing through the two points Kmin and Kmax, for example, spline interpolation or linear interpolation can be used. The method of determining the desired display brightness curve 62 is not limited to this. Moreover, a brightness curve which is generally considered as an ideal curve may be set as the desired display brightness curve 62 without using the actual brightness measurement data.

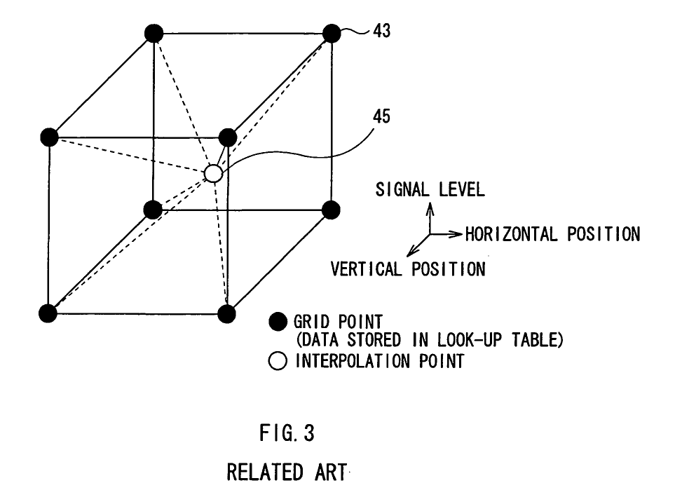

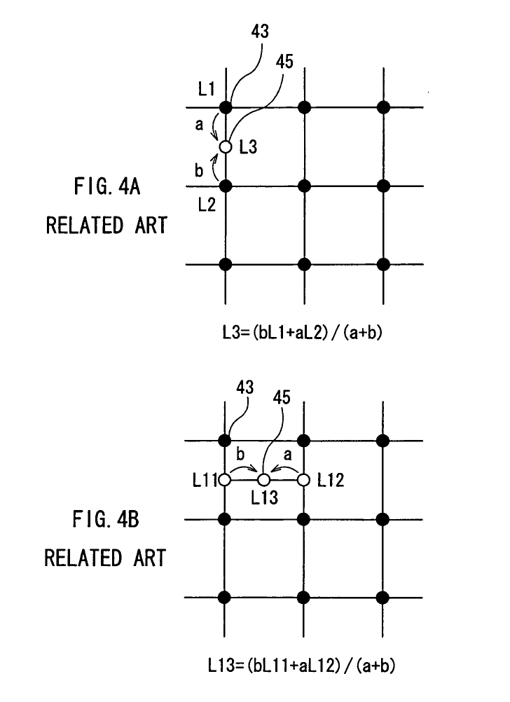

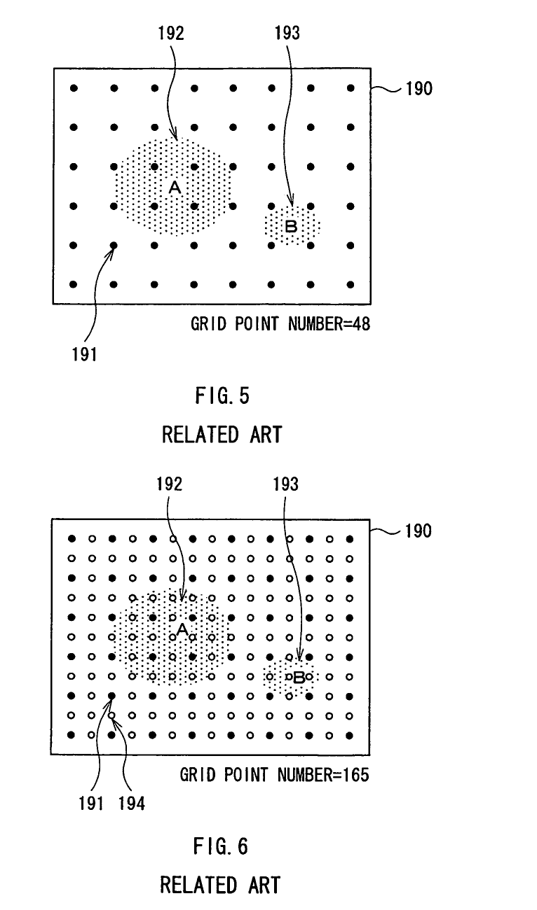

Referring back to FIG. 10, the operation will be described below. In a step of viewing the actual image signal, the selector switch 131 is turned to the adder-subtracter circuit 129 side. After a scaling process for adjusting the input image signal Vin according to the pixel number of the display panel 1, an image quality control process set by a user on the input image signal Vin, or the like is performed in the image signal processing circuit 126, the input image signal Vin is outputted to the correction data interpolation portion 128 through the LUT reference portion 127. In the correction data interpolation portion 128, the correction data stored in the LUT storing portion 125 is referred through the LUT reference portion 127, and correction data for pixels except for representative pixels is calculated by interpolation on the basis of the correction data. An interpolation method is not specifically limited, and the same method as the method described referring to FIGS. 3, 4A and 4B can be used. The correction data interpolation portion 128 directly outputs correction data for the representative pixel points at representative signal levels stored in the LUT storing portion 125 to the adder-subtracter circuit 129. Correction data for pixel points except for the representative pixel points at signal levels except for the representative signal levels calculated by interpolation is outputted to the adder-subtracter circuit 129. Thus, the correction data for all pixels at all signal levels is determined in real time, and is outputted to the adder-subtracter circuit 129. The adder-subtracter circuit 129 performs a process of adding an offset value as correction data to an input signal value or subtracting the offset value from the input signal value. Thus, when an image is displayed on the basis of the corrected image signal, a favorable image with reduced display unevenness is displayed on the display panel 1.

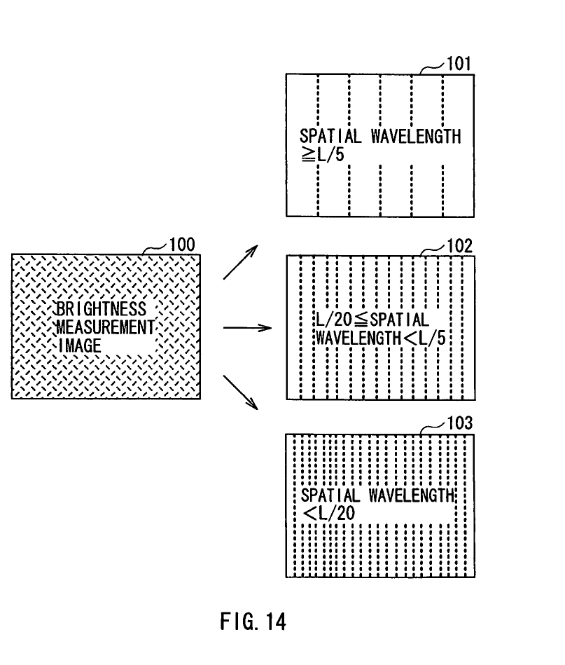

Next, referring to FIGS. 13 and 14, a specific example of a frequency separation method by the frequency separating portion 122 will be described below. Now, the case where the fineness of brightness unevenness is determined will be described as an example. In this specific example, at first, it is considered that brightness unevenness is not very dependent on the input signal level, and measurement data at one representative signal level is separated by frequency, and an area block is selected by the result. For example, data in the case where the input signal level is 64 in 8-bit conversion is used.

Measurement data 141 is, for example, 180 dots×180 dots by the precision of a brightness measuring device in the brightness measuring portion 121 (refer to FIG. 10). In a later step, it is necessary for the measurement data 141 to have a size of 2^{N} for performing FFT (Fast Fourier Transform), so in the scaling processing portion 142, the measurement data 141 is scaled to 256 dots×256 dots. This is typical linear interpolation.

Next, FFT filtering is performed by a FFT filter 143. The case where display unevenness to the extent that 20 or more Sin waveforms are shown in the horizontal width of the effective screen is determined as “very fine unevenness”, display unevenness to the extent that 5 to 20 Sin waveforms are shown is determined as “fine unevenness” and display unevenness to the extent that 5 or less Sin waveforms are shown is determined as “rough unevenness” or “no unevenness” is considered. In this case, the threshold frequency of a filter is selected so that the spatial wavelength of brightness unevenness is separated into the following three:
Spatial Wavelength≧L/5
L/20≦Spatial Wavelength<L/5
Spatial Wavelength<L/20

For example, in the case where the effective pixel number of the display panel 1 in a horizontal direction is 800, L/5=160 pixels, and L/20=40 pixels are established.

FIG. 14 conceptually shows an image separated by frequency. The data of an original brightness measurement image 100 is separated into data of three images 101, 102 and 103 in different spatial wavelength bands by a FFT filter process.

Next, in a peak detecting portion 144, the peak of the image data of “L/20≦spatial wavelength<L/5” is detected. The peak is determined by the amount of displacement from desired display brightness. The level of brightness unevenness is in a ± direction in the desired display brightness, so the result of the detected peak is the magnitude of a absolute value. On the basis of the magnitude, an area block is selected by the area block selecting portion 145. In other words, in the area block selecting portion 145, a pixel region in which the magnitude of the result of the detected peak is equal to or larger than a certain level is considered as a region with “fine unevenness”. An area including the pixel region is an area block in which the spacing between grid points are small. The area block corresponds to 6 hatched area blocks in FIG. 15. In area blocks except for the hatched area blocks, the spacing between grid points is relatively large. Thus, in the case where the brightness distribution in the effective screen at the same input signal level is separated into a plurality of spatial frequency components, a pixel region in which a relatively high spatial frequency component is observed is considered as a pixel region with fine display unevenness, and the arrangement of the grid points is set on the basis of the pixel region.

Now, the reason why the area block is selected through the use of the data of “L/20≦spatial wavelength<L/5” is that the limit range in which correction can be appropriately performed by a signal process is around the range of “L/20≦spatial wavelength<L/5”. In order to extend the limitation of the correction capability, it is necessary to increase the measurement precision and the amount of correction data stored as a look-up table; however, it is not practical. In a portion having “very fine unevenness” of “spatial wavelength<L/20”, it is desired to improve not a signal process but the structure of the panel in manufacturing.

Now, the memory amount of the look-up table stored in the LUT storing portion 125 will be considered below. In the example of FIG. 15, the number of grid points 91 is 129 for one input signal level. When the spacing between grid points are small throughout the screen, the number of grid points 91 is 165, so compared to this, data can be reduced by 20% or more.

Only the correction of brightness unevenness is described above; however, the correction of color unevenness can be performed in a like manner. In this case, the measurement is independently performed on each of colors R, G and B, and the correction data for each of the colors R, G and B may be formed.

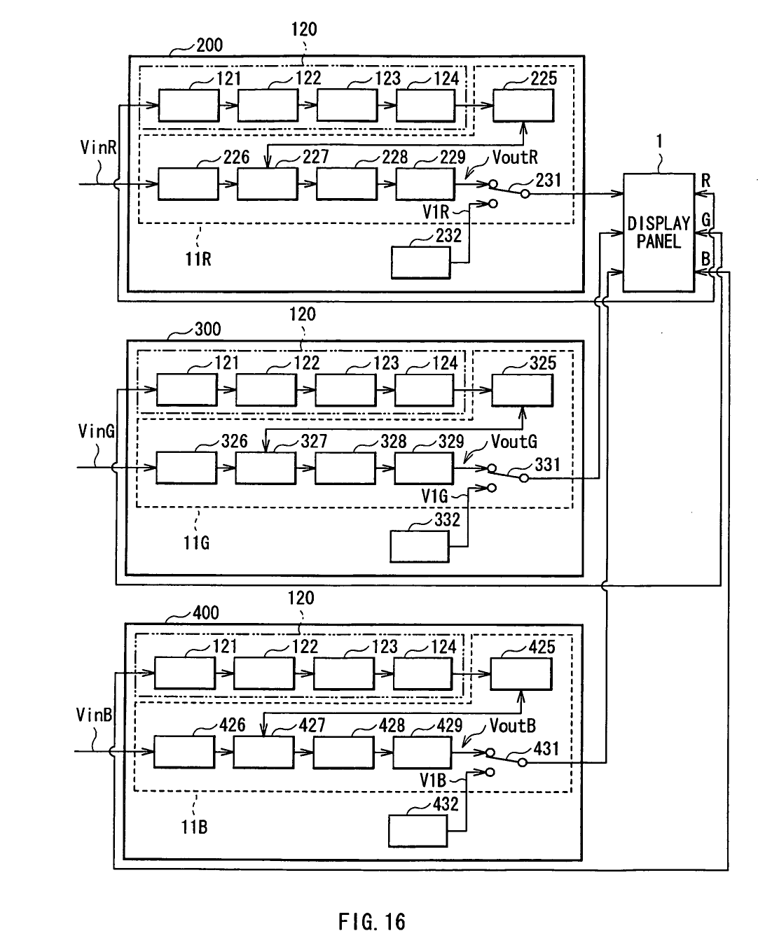

FIG. 16 shows an example of a circuit structure in the case where the correction of color unevenness is performed. A system which performs the correction of color unevenness includes a correction circuit block for R channel 200, a correction circuit block for G channel 300 and a correction circuit block for B channel 400. The same correction data forming apparatus 120 is used in each of channels R, G and B; however, for the sake of convenience, the correction data forming apparatus 120 is included in each of the blocks for each channel in the drawing. The basic structure in each circuit block is the same as the circuit structure shown in FIG. 10.

The correction circuit block for R channel 200 includes an image signal processing portion for R 11R, and a measurement image signal generating portion for R 232 disposed outside the image signal processing portion for R 11R. The image signal processing portion for R 11R includes a LUT storing portion for R 225, an image signal processing circuit for R 226, a LUT reference portion for R 227, a correction data interpolation portion for R 228, an adder-subtracter circuit for R 229, and a selector switch for R 231. The selector switch for R 231 includes two input terminals, and the adder-subtracter circuit for R 229 and the measurement image signal generating portion for R 232 are connected to the input terminals. The basic functions of the image signal processing portion for R 11R and the measurement image signal generating portion for R 232 are the same as those of the image signal processing portion 11 and the measurement image signal generating portion 132 shown in FIG. 10.

The correction circuit block for G channel 300 includes an image signal processing portion for G 11G and a measurement image signal generating portion for G 332 disposed outside the image signal processing portion for G 11G. The image signal processing portion for G 11G includes a LUT storing portion for G 325, an image signal processing circuit for G 326, a LUT reference portion for G 327, a correction data interpolation portion for G 328, an adder-subtracter circuit for G 329, and a selector switch for G 331. The selector switch for G 331 includes two input terminals, and the adder-subtracter circuit for G 329 and the measurement image signal generating portion for G 332 are connected to the input terminals. The basic functions of the image signal processing portion for G 11G and the measurement image signal generating portion for G 332 are the same as those of the image signal processing portion 11 and the measurement image signal generating portion 132 shown in FIG. 10.

The correction circuit block for B channel 400 includes an image signal processing portion for B 11B and a measurement image signal generating portion for B 432 disposed outside the image signal processing portion for B 11B. The image signal processing portion for B 11B includes a LUT storing portion for B 425, and an image signal processing circuit for B 426, a LUT reference portion for B 427, a correction data interpolation portion for B 428, an adder-subtracter circuit for B 429 and a selector switch for B 431. The selector switch for B 431 includes two input terminals, and the adder-subtracter circuit for B 429 and the measurement image signal generating portion for B 432 are connected to the input terminals. The basic functions of the image signal processing portion for B 11B and the measurement image signal generating portion for B 432 are the same as those of the image signal processing portion 11 and the measurement image signal generating portion 132 shown in FIG. 10.

Next, a method of correcting color unevenness through the use of the circuit shown in FIG. 16 will be described below. At first, in order to measure color unevenness by a test signal (image signals for measurement V1R, V1G and V1B), the selector switch for R 231, the selector switch for G 331 and the selector switch for B 431 are turned to the measurement image signal generating portion for R 232 side, the measurement image signal generating portion for G 332 side and the measurement image signal generating portion for B 432 side, respectively. At first, in order to measure a R channel, the output levels of the measurement image signal generating portion for G 332 and the measurement image signal generating portion for B 432 are 0. As the image signal for color unevenness measurement V1R, some flat field signals having a certain level interval from a black level (level 0) to a white level (maximum level) (for representative signal levels) are generated from the measurement image signal generating portion for R 232. Then, the generated signals are displayed on the R channel of the display panel 1 targeted for measurement, and the light emission level is measured by the brightness measuring portion 121 of the correction data forming apparatus 120 at each input signal level. Then, in the frequency separating portion 122, the area-specific grid point arranging portion 123 and the area-specific correction data forming portion 124, as in the case of the above-described uniformity correction, correction data only for the R channel is formed, and the correction data is stored in the LUT storing portion for R 225.

Next, in order to measure a G channel, the output levels of the measurement image signal generating portion for R 232 and the measurement image signal generating portion for B 432 are 0. As in the case of the R channel, as the image signal for color unevenness measurement V1G, some flat field signals having a certain level interval from the level 0 to the maximum level are generated from the measurement image signal generating portion for G 332. Then, the generated signals are displayed on the G channel of the display panel 1 targeted for measurement, and the light emission level is measured by the brightness measuring portion 121 of the correction data forming apparatus 120 at each input signal level. Then, in the frequency separating portion 122, the area-specific grid point arranging portion 123 and the area-specific correction data forming portion 124, as in the case of the above-described uniformity correction, correction data only for the G channel is formed, and the correction data is stored in the LUT storing portion for G 325.

Finally, in order to measure a B channel, the output levels of the measurement image signal generating portion for R 232 and the measurement image signal generating portion for G 332 are 0. As in the case of the channel R and the channel G, as the image signal for color unevenness measurement V1B, some flat field signals having a certain level interval from the level 0 to the maximum level are generated from the measurement image signal generating portion for B 432. Then, the generated signals are displayed on the B channel of the display panel 1 targeted for measurement, and the light emission level is measured by the brightness measuring portion 121 of the correction data forming apparatus 120 at each input signal level. Then, in the frequency separating portion 122, the area-specific grid point arranging portion 123 and the area-specific correction data forming portion 124, as in the case of the above-described uniformity correction, correction data only for the B channel is formed, and the correction data is stored in the LUT storing portion for B 425.

When the correction data is stored, the selector switch for R 231, the selector switch for G 331 and the selector switch for B 431 are turned back to the adder-subtracter circuit for R 229 side, the adder-subtracter circuit for G 329 side an the adder-subtracter circuit for B 429 side, respectively, so as to be changed to a normal operation. A signal process except for the correction of color unevenness is performed on the inputted image signals for R, G and B VinR, VinG and VinB by the image signal processing circuit for R 226, the image signal processing circuit for G 326 and the image signal processing circuit for B 426, respectively. In the correction data interpolation portion for R 228, the correction data interpolation portion for G 328, the correction data interpolation portion for B 428, correction data stored in the LUT storing portion for R 225, the LUT storing portion for G 325 and LUT storing portion for B 425 are referred through the LUT reference portion for R 227, the LUT reference portion for G 327 and LUT reference portion for B 427, respectively, and on the basis of the correction data, correction data for pixels except for the representative pixel points is calculated by interpolation. In the correction data interpolation portion for R 228, the correction data interpolation portion for G 328 and the correction data interpolation portion for B 428, the correction data for the representative pixel points at the representative signal levels stored in a LUT is directly outputted to the adder-subtracter circuit for R 229, the adder-subtracter circuit for G 329 and the adder-subtracter circuit for B 429. Correction data for pixel points except for the representative pixel points at signal levels except for the representative signal level calculated by the interpolation operation is outputted to the adder-subtracter circuit for R 229, the adder-subtracter circuit for G 329 and the adder-subtracter circuit for B 429. An interpolation method for each color is the same as in the case of the above-described uniformity correction. Thus, the correction data for all pixels at all signal levels in each color is determined in real time, and is outputted to the adder-subtracter circuit for R 229, the adder-subtracter circuit for G 329 and the adder-subtracter circuit for B 429. The adder-subtracter circuit for R 229, the adder-subtracter circuit for G 329 and the adder-subtracter circuit for B 429 each perform a process of adding an offset value as correction data to an original input signal value or subtracting the offset value from the original input signal value. Thus, when an image is displayed on the basis of the corrected image signal, a favorable image with reduced color unevenness is displayed on the display panel 1.

Thus, an image of which the color unevenness is corrected can be displayed on the display panel 1. The order of the measurement of each channel is not limited to the above-described order, and can be freely changed.

As described above, in the embodiment, the representative pixel points (grid points) are arranged according to display unevenness measured before a correction process so that more pixel points are arranged in a pixel region with relatively finer display unevenness, and the correction data stored in the LUT storing portion 125 is allocated more to the pixel region with relatively finer display unevenness according to the display unevenness, so while a correction process with higher precision is performed on the pixel region with finer unevenness, a correction process with minimum precision is performed on a pixel region with rough unevenness through reducing correction data stored in the LUT storing portion 125. Thereby, while correction data prepared in advance can be minimized so as to reduce the memory amount, the capability of uniformity correction can be improved, compared to the related art.

The invention is not limited to the above-described embodiment, and can be variously modified. For example, in the above-described embodiment, a voltage drive type driving method in which the magnitude of the brightness is variable according to the voltage level of the voltage Vgc between the gate and the cathode is described as an example; however, the invention can be easily applied to a pulse drive type driving method in which the voltage level of the voltage Vgc between the gate and the cathode is fixed, and grayscale is represented according to the time when the voltage Vgc is applied. Further, the case where the FED is used as the display panel 1 is described as an example; however, the invention can be applied to the case where any other types of display panels such as an EL type display panel are used.

Moreover, in the above-described embodiment, the arrangement of the grid points is the same at each signal level; however, the arrangement of the grid points may be changed at each signal level. When unevenness is substantially the same at each signal level, the capability of uniformity correction is not changed even in the same arrangement. However, in the case where unevenness is different at each signal level, when the arrangement is changed according to each signal level, the capability of uniformity correction can be further improved.

It should be understood by those skilled in the art that various modifications, combinations, sub-combinations and alterations may occur depending on design requirements and other factors insofar as they are within the scope of the appended claims or the equivalents thereof.

What is claimed is:

1. An image display unit including a plurality of pixels, and controlling the level of display brightness on a pixel-by-pixel basis, the image display unit comprising:
a storing means for storing correction data for correcting display unevenness between pixels for representative pixel points set in an effective screen;
an interpolation means for calculating correction data for pixels except for the representative pixel points by interpolation through referring to the correction data stored in the storing means; and
a signal processing means for performing a correction process on an input signal on the basis of the correction data stored in the storing means and the correction data calculated by interpolation so that display brightness at the same input signal level becomes the same between pixels,
wherein the arrangement of the representative pixel points is set according to display unevenness measured before performing the correction process so that the representative pixel points are arranged with a higher density in a pixel region with relatively finer display unevenness than in a pixel region with rough display unevenness in the effective screen, and
the correction data stored in the storing means is allocated more to the pixel region with relatively finer display unevenness according to the measured display unevenness, compared to the pixel region with rough display unevenness.

2. An image display unit according to claim 1, wherein
the storing means stores correction data for the representative pixel points at representative signal levels, and
the interpolation means calculates correction data for a signal level except for the representative signal levels by interpolation through referring to the correction data stored in the storing means.

3. An image display unit according to claim 1, wherein
a desired brightness curve showing an ideal relationship of display brightness to an input signal level in the representative pixel points is set,
the storing means stores data of an offset value for conforming a brightness curve in the representative pixel points to the desired brightness curve as the correction data, and
the signal processing means performs a process of adding the offset value to an input signal value or subtracting the offset value from the input signal value as a correction process on the input signal.

4. An image display unit according to claim 1, wherein
in the case where the brightness distribution in the effective screen in the same input signal level is separated into a plurality of spatial frequency components, a pixel region in which a relatively high spatial frequency component is observed is set as a pixel region with fine display unevenness.

5. A method of correcting brightness in an image display unit, the image display unit including a plurality of display pixels and controlling the level of display brightness on a pixel-by-pixel basis, the method comprising the steps of:
storing correction data for correcting display unevenness between pixels for representative pixel points set in an effective screen;
calculating correction data for pixels except for the representative pixel points by interpolation through referring to the stored correction data; and
performing a correction process on an input signal on the basis of the stored correction data and the correction data calculated by interpolation so that display brightness at the same input signal level becomes the same between pixels,
wherein the arrangement of the representative pixel points is set according to display unevenness measured before performing the correction process so that the representative pixel points are arranged with a higher density in a pixel region with relatively finer display unevenness than in a pixel region with rough display unevenness in the effective screen, and
the stored correction data is allocated more to the pixel region with relatively finer display unevenness according to the measured display unevenness, compared to the pixel region with rough display unevenness.

6. A method of correcting brightness in an image display unit according to claim 5, wherein
a desired brightness curve showing an ideal relationship of display brightness to an input signal level in the representative pixel points is set,
in the storing step, data of an offset value for conforming a brightness curve in the representative pixel points to the desired brightness curve is stored as the correction data, and
the step of performing the correction process on the input signal, a process of adding the offset value to an input signal value or subtracting the offset value from the input signal value is performed as a correction process on the input signal.

7. A method of correcting brightness in an image display unit according to claim 5, wherein
in the case where the brightness distribution in the effective screen in the same input signal level is separated into a plurality of spatial frequency components, a pixel region in which a relatively high spatial frequency component is observed is set as a pixel region with fine display unevenness.

8. An image display unit including a plurality of pixels, and controlling the level of display brightness on a pixel-by-pixel basis, the image display unit comprising:
a storing section storing correction data for correcting display unevenness between pixels for representative pixel points set in an effective screen;
an interpolation section calculating correction data for pixels except for the representative pixel points by interpolation through referring to the correction data stored in the storing section; and
a signal processing section performing a correction process on an input signal on the basis of the correction data stored in the storing section and the correction data calculated by interpolation so that display brightness at the same input signal level becomes the same between pixels,
wherein the arrangement of the representative pixel points is set according to display unevenness measured before performing the correction process so that the representative pixel points are arranged with a higher density in a pixel region with relatively finer display unevenness than in a pixel region with rough display unevenness in an effective screen, and
the correction data stored in the storing section is allocated more to the pixel region with relatively finer display unevenness according to the measured display unevenness, compared to the pixel region with rough display unevenness.
